(19) United States
(12) Patent Application Publication
(10) Pub. No.: US 2015/0242369 A1
(43) Pub. Date: Aug. 27, 2015

(54) DOCUMENT DISTRIBUTION SERVER AND PROGRAM

(71) Applicant: TOSHIBA TEC KABUSHIKI KAISHA, Tokyo (JP)

(72) Inventors: Takahiro HAGIWARA, Chiba Chiba (JP); Akihiro MIZUTANI, Mishima Shizuoka (JP); Shinji MAKISHIMA, Suntou Shizuoka (JP); Toshihiro IDA, Mishima Shizuoka (JP); Yusuke HAMADA, Mishima Shizuoka (JP); Hiroshi WATANABE, Yokohama Kanagawa (JP); Ken SAKUTA, Izunokuni Shizuoka (JP)

(21) Appl. No.: 14/626,772

(22) Filed: Feb. 19, 2015

(30) Foreign Application Priority Data
Feb. 21, 2014 (JP) 2014-032058

(51) Int. Cl. G06F 17/21; G06T 11/60; G06K 15/02; G06F 17/24

(52) U.S. Cl. CPC G06F 17/211; G06F 17/24; G06T 11/60; G06K 15/1852; G06K 15/1886; G06K 15/181

(57) ABSTRACT

A document data distribution server includes a storage unit, a communication unit configured to receive document data of a document, image data of an image added to the document, and a request for integrated document data, and a control unit. The control unit is configured to compress the document data and control the storage unit to store the compressed document data when the communication unit receives the document data, control the storage unit to store the image data when the communication unit receives the image data, generate, as the integrated document data, data of a first layer that includes the compressed document data and data of a second layer to be superimposed on the first layer, that includes the image data of the added image, and control the communication unit to output the integrated document data, when the communication unit receives the request.

### CROSS-REFERENCE TO RELATED APPLICATION

This application is based upon and claims the benefit of priority from Japanese Patent Application No. 2014-032058, filed Feb. 21, 2014, the entire contents of which are incorporated herein by reference.

### FIELD

Embodiments described herein relate generally to a document distribution server, and a document distribution program.

### BACKGROUND

One type of a document distribution server distributes document data that is in a raster format to a plurality of terminal devices. The document data in the raster format may be further compressed prior to distribution. When an image is added to the document through a terminal device, the document distribution server integrates the added image to the document data.

In order to integrate the added image to the document data, the document distribution server decompresses the compressed document data, and performs integration processing with respect to the decompressed document data and the data of the added image. Then the integrated document data is compressed into the format for distribution again. Thus, the above-described process carried out by a document distribution server to integrate the added image to the document may require a significant amount of time.

### DESCRIPTION OF THE DRAWINGS

FIG. 1 illustrates a document distribution system including a server according to an embodiment.

FIG. 2 illustrates the server according to the embodiment.

FIG. 3 illustrates a document data layer and drawing layers superimposed thereon.

FIG. 4 illustrates image-added document data according to an embodiment.

FIG. 5 is a flow chart illustrating processing carried out by the server according to an embodiment.

### DETAILED DESCRIPTION

An embodiment provides a document distribution server and a document distribution server program with improved convenience.

In general, according to one embodiment, a document data distribution server includes a storage unit, a communication unit configured to receive document data of a document, image data of an image added to the document, and a request for integrated document data including the document data and the image data, and a control unit. The control unit is configured to compress the document data and control the storage unit to store the compressed document data when the communication unit receives the document data, control the storage unit to store the image data when the communication unit receives the image data, generate, as the integrated document data, data of a first layer that includes the compressed document data and data of a second layer to be superimposed on the first layer, that includes the image data of the added image, and control the communication unit to output the integrated document data, when the communication unit receives the request.

Hereinafter, a document distribution server and a document distribution server program according to an embodiment will be described in detail.

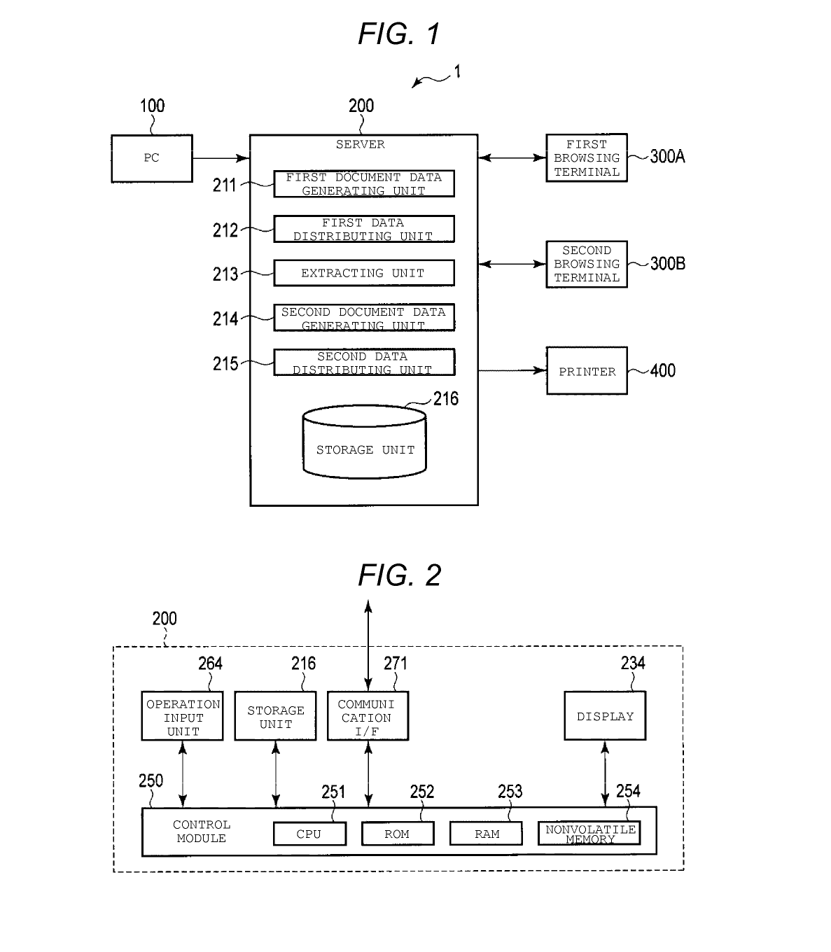

FIG. 1 illustrates a document distribution system 1 according to an embodiment. The document distribution system 1 includes a PC 100, a server 200, a browsing terminal 300, a printer 400, and the like.

The document distribution system 1 includes a first browsing terminal 300A, a second browsing terminal 300B, and the like as the browsing terminals 300. When it is not necessary to distinguish between the first browsing terminal 300A and the second browsing terminal 300B, the first and second browsing terminals 300A and 300B are generally referred to as the browsing terminal 300. In this example, the document distribution system 1 may include several browsing terminals 300 and several printers 400.

The PC 100, the server 200, the browsing terminal 300, and the printer 400 are connected to each other through a network. That is, the PC 100 and the server 200 may transmit and receive data. Further, the server 200, the browsing terminal 300, and the printer 400 may transmit or receive data. The network may be a LAN, the Internet, a wireless communication network, or the like.

The PC 100 is a general computer. The PC 100 functions as a printer driver. The PC 100 includes a communication I/F, a storage unit, a control unit, and the like, for example. The communicating unit may perform communication with other devices in the network. The storage unit may store document data. The control unit may read out the document data from the storage unit, and may operates to store the read-out document data in the server 200. That is, the PC 100 may upload the document data to the server 200 through the network. Further, the PC 100 may instruct the server 200 to perform a printing process.

When instructing the printing process, the PC 100 converts the document data into a page description language (PDL) data. The converted PDL data is transmitted to the document distribution server 200. According to this conversion, the PC 100 may operate to store the document data in the server 200 in a format of being printable by the printer 400.

The document data has a specific ID (document ID). Further, each page of the document data has a page ID. That is, a terminal device that can display the document data may specify a document and a page of the document data to be displayed based on the document ID and the page ID.

The server 200 includes a display 234, a control module 250, an operation input unit 264, a communication I/F 271, and a storage unit 216.

The control module 250 functions as a control unit that controls operations of the respective units of the server 200. The control module 250 includes a CPU 251, a ROM 252, a RAM 253, a nonvolatile memory 254, and the like (FIG. 2). The control module 250 performs various processes based on an operation signal transmitted from the operation input unit 264.

The CPU 251 includes an arithmetic element or the like that executes various arithmetic operations. The CPU 251 achieves various functions by executing a program stored in the ROM 252, the nonvolatile memory 254, or the like.

The ROM 252 stores a program for controlling the server 200, a program for achieving various functions, or the like. The CPU 251 starts the program stored in the ROM 252 based on an operation signal transmitted from the operation input unit 264. Thus, the control module 250 controls the operations of the respective units.

The RAM 253 functions as a work memory of the CPU 251. That is, the RAM 253 stores an arithmetic result of the CPU 251, data read out by the CPU 251, or the like.

The nonvolatile memory 254 is a nonvolatile memory that stores various setting information, programs, or the like.

Further, the CPU 251 may execute various processes based on data such as an application stored in the storage unit 216.

Further, the control module 250 may generate a video signal for various screens or the like to be displayed on the display 234 according to the application executed by the CPU 251. Further, the control module 250 may generate an audio signal for various sound or the like to be output through a speaker according to the application executed by the CPU 251 (not illustrated).

The display 234 is a display device that includes a display panel including plural pixels that are disposed in a matrix form, for example. The display 234 displays a video image based on the video signal.

The operation input unit 264 includes keys that causes an operation signal to be generated in response to operation of the key by a user, for example. The operation input unit 264 includes, for example, a device or the like that receives a signal from an operation input device such as a keyboard or a mouse. The operation input unit 264 supplies the generated operation signal to the control module 250.

The communication I/F 271 may perform communication with other devices in the network. Thus, the server 200 may perform communication with the PC 100, the browsing terminal 300, and the printer 400 connected to the network. Further, the communication I/F 271 may directly perform communication with the PC 100, the browsing terminal 300, and the printer 400 without using the network.

The storage unit 216 includes a storage device such as a hard disk drive (HDD), a solid state drive (SSD), a semiconductor memory, or the like. The storage unit 216 may store a program and an application executed by the CPU 251 of the control module 250, various data, or the like. The storage unit 216 stores an operating system (OS), and various applications capable of being executed on the OS, for example.

Further, the storage unit 216 may store document data, additional image data (described below), image addition information supplied from the browsing terminal 300, or the like.

The control module 250 of the server 200 has a function of a first document data generating unit 211, a first document data distributing unit 212, an extracting unit 213, a second document data generating unit 214, a second document data distributing unit 215, or the like, by executing the program.

When the PDL transmitted from the PC 100 is received, the first document data generating unit 211 executes raster image processing (hereinafter, referred to as RIP processing), and generates document data for browsing from the received PDL. The document data for browsing is raster image data suitable for displaying on the browsing terminal 300.

The first document data distributing unit 212 distributes the document data generated by the first document data generating unit 211 to a predetermined terminal device (for example, the browsing terminal 300 or the like). As a result, the browsing terminal 300 may display each page of the document data for browsing.

The server 200 may select document data to be distributed to the browsing terminal 300 using identification information (terminal ID) for each browsing terminal 300. For example, the server 200 retains conference information in which a conference ID, a conference date and time, a conference title, a document ID, a terminal ID of the browsing terminal 300 of a participant, and the like are correlated with each other. The server 200 acquires the terminal ID from the browsing terminal 300, and refers to the conference information correlated with the acquired terminal ID. The server 200 may distribute document data of the document ID correlated with the referenced conference information, to the browsing terminal 300.

For example, the browsing terminal 300 is a mobile phone terminal, a tablet PC, a portable music player, or other electronic devices. The browsing terminal 300 transmits the terminal ID to the server 200. Thus, the browsing terminal 300 can receive the document data from the server 200.

Further, the browsing terminal 300 may open the received document data. Thus, the browsing terminal 300 may display an arbitrary page of the document data.

The browsing terminal 300 includes a control unit, a display, an operation input unit, a storage unit, a communicating unit, and the like.

The storage unit stores an operating system (OS), and various applications capable of being executed on the OS, for example. The storage unit includes an application (document viewer) for opening the document data, for example.

The control unit of the browsing terminal 300 may open the above-mentioned document data by executing the document viewer. Thus, the control unit may generate a video signal according to the document data such that each page of the document data can be displayed on the display. As a result, the control unit may operate to display an arbitrary page of the received document data on the display.

Further, the control unit of the browsing terminal 300 may superimpose a transparent layer (note) on a page of the document data that is displayed. Further, the control unit of the browsing terminal 300 may operate to display an image drawn based on an operation signal input on the note. For example, when the operation input unit is a touch sensor, the control unit of the browsing terminal 300 may operates to display a track of coordinate information input by a touch sensor on the note as an image. That is, the control unit of the browsing terminal 300 may perform image addition with respect to the page of the document data when the user draws the image on the note.

Further, the control unit of the browsing terminal 300 can generate drawing information based on the note on which the image is drawn. The drawing information refers to information indicating an image drawn on a page of the document data. The drawing information indicates the track of the coordinate input by the operation as described above, for example. The control unit of the browsing terminal 300 may superimpose an image based on the drawing information on the page of the document data for display.

The note includes a private note and a shared note. The private note is a layer in which the image addition is performed through each browsing terminal 300. Further, the shared note is a layer in which image addition is performed and the added image can be browsed by plural browsing terminals 300. The control unit of the browsing terminal 300 may switch a layer in which the image is added between the private note and the shared note. Further, the control module 250 may individually generate the drawing information on the private note and the shared note, respectively. Further, the control unit of the browsing terminal 300 may individually switch display and non-display of the drawing information on the private note and the shared note, respectively.

In addition, the control unit of the browsing terminal 300 may transmit the drawing information generated based on the private note and the shared note to the server 200 as image addition information. The image addition information includes a document ID, a page ID, attribution information, drawing information, and the like. The document ID and the page ID represents document data and a page where image addition is performed. The attribution information is information indicating a note (for example, private note or shared note) and a terminal ID where the image addition is performed. That is, the image addition information includes drawing information, and information indicating a writing destination of the drawing information.

When the image addition information is received from the browsing terminal 300, the server 200 operates to store the received image addition information in the storage unit 216. The server 200 accumulates the image addition information received from the browsing terminal 300 in the storage unit 216.

When there is a request such as a print request or a download request from the browsing terminal 300, the extracting unit 213 recognizes a condition included in the request. The condition includes a document ID of target document data to be printed or downloaded, a page ID of a target page, color designation, white and black designation, attribute information, and the like. When there is the print or download request from the browsing terminal 300, the extracting unit 213 extracts the document data and the image addition information from the storage unit 216 according to the condition included in the request. That is, the extracting unit 213 extracts an image of a page corresponding to the page ID designated by the request, of document data corresponding to the document ID designated by the request, from the storage unit 216. Further, the extracting unit 213 extracts the image addition information of which the document ID, the page ID, and the attribution information match the request from the storage unit 216.

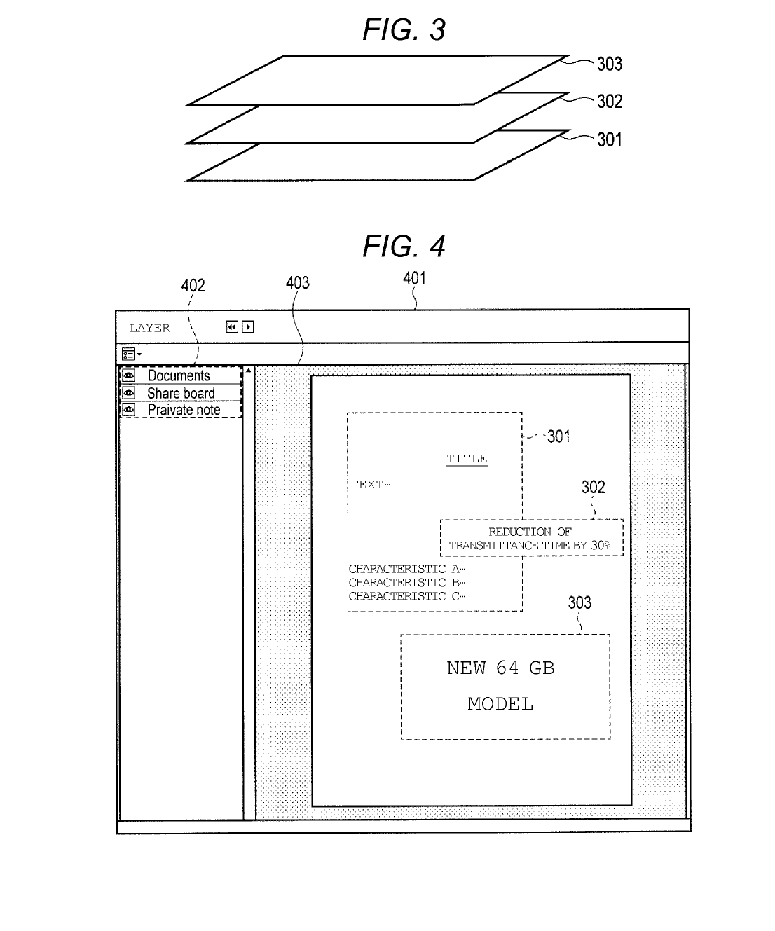

The second document data generating unit 214 generates image-added document data in which an image is added based on the image of the document data extracted by the extracting unit 213 and the image addition information. The image-added document data includes plural layers that are switchable between display and non-display. As illustrated in FIG. 3, the second document data generating unit 214 generates a document data layer 301, a first drawing layer 302, and a second drawing layer 303, and superimposes the respective layers to generate the image-added document data.

The second document data generating unit 214 generates the document data layer 301 from the document data extracted by the extracting unit 213. The document data layer 301 is a layer in which an image of a page corresponding to the document ID and the page ID indicated by the image addition information is drawn.

The second document data generating unit 214 generates a drawing layer based on the image addition information extracted by the extracting unit 213. The drawing layer is a layer superimposed on the page designated by the document ID and the page ID indicated by the image addition information. That is, the drawing layer is a layer superimposed on the document data layer. The second document data generating unit 214 allows an image to be drawn on the drawing layer based on the drawing information of the image addition information. Thus, the second document data generating unit 214 can superimpose, as the drawing layer, an image additionally written through the browsing terminal 300 on the document data layer.

The second document data generating unit 214 generates a layer for each attribute indicated by the attribution information of the image addition information. For example, it is assumed that two pieces of image addition information having the same document ID, page ID, and terminal ID, and respectively having additional image of “private note” and “shared note” are stored in the storage unit 216. In this case, the second document data generating unit 214 generates the first drawing layer 302 corresponding to “private note,” and the second drawing layer 303 corresponding to “shared note.” The second document data generating unit 214 superposes the first drawing layer 302 and the second drawing layer 303 on the document data layer 301 to generate the image-added document data.

Further, the second document data generating unit 214 may generate a layer for each terminal ID. In addition, the second document data generating unit 214 may generate a layer for each combination of a terminal ID and information indicating a note. According to this configuration, the second document data generating unit 214 may generate image-added document data capable of switching layers where a terminal ID and a note are designated to be displayed in detail.

The second document data distributing unit 215 distributes the image-added document data generated by the second document data generating unit 214 to the browsing terminal 300 that has transmitted the download request. Then, the browsing terminal 300 may display an image corresponding to the image-added document data in which an image has been added.

FIG. 4 illustrates a display example of the image corresponding to the image-added document data.

The browsing terminal 300 executes a program for the document viewer to display a window 401. The window 401 includes a layer display region 402 and a document display region 403. The layer display region 402 is a region where a layer included in the image-added document data and an icon for switching display and non-display of each layer are displayed in combination. The document display region 403 is a region where an image of the layer included in the image-added document data is displayed.

The browsing terminal 300 may switch a layer displayed in the document display region 403 according to an operation on the layer display region 402. For example, in the example illustrated in FIG. 4, the image-added document data includes the document data layer 301, the first drawing layer 302, and the second drawing layer 303. For example, when the first drawing layer 302 is set to the non-display, an image obtained by superimposing the document data layer 301 and the second drawing layer 303 is displayed in the display region 403.

As described above, the server 200 may distribute the image-added document data for which display and non-display of images is switchable on the browsing terminal 300, to the browsing terminal 300. That is, the server 200 does not need to distribute document data to the browsing terminal 300 again according to the switching of the information to be displayed. Thus, the server 200 may reduce time necessary for distribution of the image-added document data.

Further, when the print request is transmitted from the browsing terminal 300, the second document data distributing unit 215 distributes the image-added document data generated by the second document data generating unit 214 to the printer 400. The printer 400 may print the image-added document data distributed from the server 200.

In addition, the printer 400 may display the image-added document data distributed from the server 200 on a display unit (not illustrated) or the like, similar to the browsing terminal 300. The printer 400 displays a display region corresponding to the layer display region 402 in FIG. 4 and a display region corresponding to the document display region 403 on the display unit. The printer 400 displays the layer display region 402 on the display unit in a state of being selectable according to an operation. The printer 400 may switch the layer to be displayed in the document display region 403 according to an operation on the layer display region 402. Further, when a print start icon (not illustrated) is operated, the printer 400 prints an image displayed in the document display region 403. That is, the server 200 may distribute the image added document data obtained by switching information to be printed on the side of the printer 400, to the printer 400. That is, the server 200 does not need to distribute the document data to the printer 400 again according to the switching of the information to be printed. Thus, the server 200 may reduce time necessary for distribution of the image added document data.

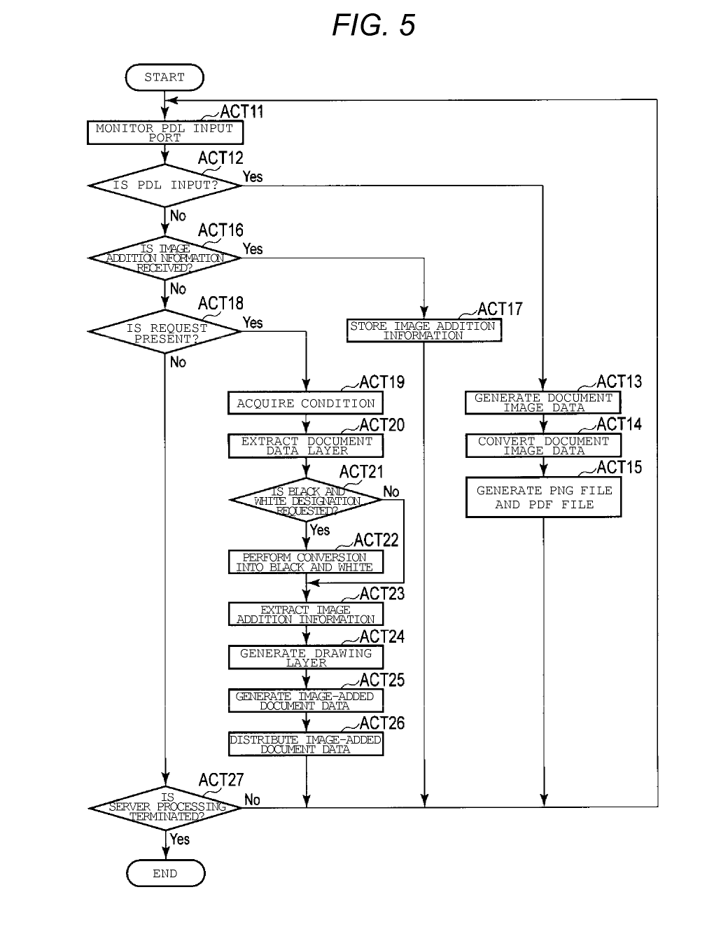

FIG. 5 illustrates an example of processing of the server 200.

The control module 250 of the server 200 monitors an input port of PDL (ACT 11). Then, the control module 250 determines whether the PDL is input from the PC 100 having the printer driver (ACT 12).

When the PDL is input, the control module 250 generates document image data for distribution (ACT 13). That is, the control module 250 performs RIP processing with respect to the received PDL to generate raster image data (document image data).

Then, the control module 250 converts the document image data (ACT 14). The control module 250 performs color reduction processing with respect to the generated raster image data in order to reduce a data size and reduce a processing time during color conversion. Thus, the control module 250 converts the raster image data generated in ACT 13 into raster image data of an index color format.

Then, the control module 250 generates a PNG file and a PDF file based on the color-reduced raster image data (ACT 15), and returns to ACT 11. That is, the control module 250 compresses the color-reduced raster image data by a compression method using a PNG image format, to generate document data for browsing (PNG file). As a result, the control module 250 can distribute the document data for browsing to the browsing terminal 300.

Further, the control module 250 compresses the color-reduced raster image data by a compression method using a PDF format used for storage or printing, to generate document data for storage and printing (PDF file). In this case, the control module 250 embeds raster image data corresponding to all pages of the document data to the PDF file. Further, the control module 250 records information indicating a position of the raster image data corresponding to each page on the PDF file in the PDF file as a table. Referring to the table, compression image data of an arbitrary page maybe read at high speed.

Furthermore, when the PDL is not input in ACT 12 (ACT 16 No), the control module 250 determines whether the image addition information is received (ACT 16). If the image addition information is received (ACT 16 Yes), the control module 250 stores the image addition information in the storage unit 216 (ACT 17), and returns to ACT 11.

Further, if the image addition information is not received (ACT 16 No), the control module 250 determines whether a request such as a download request or a print request is received (ACT 18). If the request is received (ACT 18 Yes), the control module 250 acquires a condition included in the request (ACT 19). As a result, the control module 250 may recognize a document ID of target document data to be printed or downloaded, a page ID of a target page, color designation, white and black designation, attribute information, and the like.

Then, the control module 250 extracts the document data layer (ACT 20). The control module 250 extracts the compression image data of the document data (PDF file) for the document data storage and printing stored in the storage unit 216 as the document data layer. The control module 250 extracts the compression image data corresponding to the document ID and the page ID recognized from the condition, with reference to the table of the PDF file. The compression image data of the PDF file is data in a format of being directly superimposed on the layer of the document data for storage and printing. That is, the control module 250 may use the compression image data of the PDF file as the document data layer as it is. Accordingly, compared with a case where the compression image data of the PNG file is extracted, decompression processing, re-compression processing or the like is not required.

Then, the control module 250 determines whether the black and white designation is requested based on the recognized condition (ACT 21). When the black and white designation is requested, the control module 250 converts the extracted compression image data into a black-and-white image (ACT 22). As described above, the compression image data is generated as the raster image data of the index color format. Thus, the control module 250 may convert values of the table of the index color into black and white to convert the compression image data into the black-and-white image.

Then, the control module 250 extracts the image addition information from the storage unit 216 according to the recognized condition (ACT 23). That is, the control module 250 extracts the image addition information of which the document ID, the page ID, and the attribute information match the request, from the storage unit 216.

Then, the control module 250 generates a drawing layer based on the extracted image addition information (ACT 24). That is, the control module 250 includes an image on the drawing layer based on the drawing information of the extracted image addition information. Thus, the control module 250 may generate one drawing layer based on one piece of image addition information. The control module 250 creates drawing layers based on the entirety of the extracted image addition information. When there are plural pieces of image addition information of which the document ID, the page ID, and the attribute information match the request, the control module 250 may include images to one drawing layer according to the plural pieces of the image addition information.

The control module 250 superimposes the document data layer and the drawing layer in a state of being switchable between display and non-display, and generates image-added document data (ACT 25).

The control module 250 distributes the generated image-added document data (ACT 26), and returns to ACT 11. When the download request is received in ACT 18, the control module 250 distributes the image-added document data to the browsing terminal 300 that has transmitted the request. Further, when the print request is received in ACT 18, the control module 250 distributes the image-added document data to the printer 400.

Further, when the request is not received in ACT 18, the control module 250 determines whether termination of the processing of the server 200 is instructed (ACT 27). If the termination of the processing of the server 200 is not instructed (ACT 27 No), the control module 250 returns to ACT 11. As described above, the control module 250 may sequentially execute the processes of ACT 11 to ACT 26. Further, if the termination of the processing of the server 200 is instructed, the control module 250 terminates the processing.

As described above, the server 200 for document distribution generates the document data for browsing and the document data for printing and storing when the document data is registered. Further, the server 200 sequentially stores the image addition information acquired from the browsing terminal 300. Further, when the download request, the print request, or the like is received from the browsing terminal 300, the server 200 extracts the image of the document data and the page that satisfy the condition included in the request from the document data for printing and storing, and extracts the image addition information that satisfies the condition included in the request. The server 200 generates the document data layer from the image extracted from the document data, and generates the drawing layer from the extracted image addition information. The server 200 superimposes the document data layer and the drawing layer in a state of being switchable between display and non-display to generate the image-added document data.

According to the server 200 with this configuration, even when the download request, the print request, and the like are received from the plural browsing terminals 300 plural times, since it is not necessary to perform decompression, re-compression, or the like of an image, the image-added document data may be distributed in a short time. Thus, the server 200 may distribute the image-added document data including different additional content to each user in a short time. As a result, it is possible to provide a document distribution server and a document distribution program with improved convenience.

The respective functions described in the exemplary embodiments are not limited to a configuration using hardware, but may be achieved by allowing a computer to read a program in which the respective functions are written using software. Further, the respective functions may be configured by appropriately selecting any one of software and hardware.

In the exemplary embodiment, a case where the function for achieving the exemplary embodiment is stored in the apparatus in advance is described, but the exemplary embodiment is not limited thereto, and the same function may be downloaded to the apparatus from the network, or the same function may be stored in a recording medium to be installed to the apparatus. As the recording medium, any type of a recording medium capable of storing a program such as a CD-ROM and capable of being read by the apparatus may be used. Further, functions that may be obtained by installation or downloading in advance may be achieved in cooperation with an operating system (OS) or the like in the apparatus.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A document data distribution server comprising:
a storage unit;
a communication unit configured to receive document data of a document, image data of an image added to the document, and a request for integrated document data including the document data and the image data; and
a control unit configured to
compress the document data and control the storage unit to store the compressed document data when the communication unit receives the document data,
control the storage unit to store the image data when the communication unit receives the image data,
generate, as the integrated document data, data of a first layer that includes the compressed document data and data of a second layer to be superimposed on the first layer, that includes the image data of the added image, and
control the communication unit to output the integrated document data, when the communication unit receives the request.

2. The document data distribution server according to claim 1, wherein
the communication unit is further configured to receive second image data of a second image added to the document, and
the control unit is further configured to control the storage unit to store the second image data when the communication unit receives the second image data.

3. The document data distribution server according to claim 2, wherein
the integrated document data generated by the control unit further includes data of a third layer to be superimposed on the first and second layers, that includes the second image.

4. The document data distribution server according to claim 1, wherein
the control unit is configured to compress the document data into a first format for storage in the storing unit and into a second format for outputting to a predetermined display device, when the communication unit receives the document data.

5. The document data distribution server according to claim 4, wherein
the first format is portable document format (PDF), and the second format is portable network graphics (PNG) format.

6. The document data distribution server according to claim 5, wherein
the integrated document data is further output to a printing device.

7. The document data distribution server according to claim 1, wherein
the control unit is further configured to rasterise the document data when the communication unit receives the document data, and
the control unit compresses the rasterised document data.

8. The document data distribution server according to claim 7, wherein
the control unit is further configured to convert the rasterised document data into an index color format when the communication unit receives the document data, and
the control unit compresses the converted document data.

9. The document data distribution server according to claim 1, wherein
the integrated document data is set such that display and non-display of the added image on the second layer is selectable.

10. A method for distributing document data comprising:
receiving document data of a document;
compressing the received document data;
storing the compressed document data;
receiving image data of an image added to the document;
storing the received image data;
receiving a request for integrated document data including the document data and the image data;
generating, as integrated document data, data of a first layer that includes the document of the compressed document data and data of a second layer that is to be superimposed on the first layer, that includes the image data of the added image; and
outputting the generated integrated document data when the request is received.

11. The method according to claim 10, further comprising:
receiving second image data of a second image added to the document; and
storing the second image data.

12. The method according to claim 11, further comprising:
the generated integrated document data includes data of a third layer that is superimposed on the first and second layers, that includes the second image.

13. The method according to claim 10, wherein the document data is compressed into a first format for the storing in the storage unit, the method further comprising:
compressing the document data into a second format that is different from the first format in response to receiving of the document data; and
outputting the document data in the second format to a predetermined display device when the document data is received.

14. The method according to claim 13, wherein
the first format is portable document format (PDF), and the second format is portable network graphics (PNG) format.

15. The method according to claim 14, further comprising:
outputting the integrated document data to a printing device.

16. The method according to claim 10, further comprising:
rasterising the received document data, wherein
the rasterised document data is compressed.

17. The method according to claim 16, further comprising:
converting the rasterised document data into an index color format when the document data is received, wherein converted document data is compressed.

18. The method according to claim 10, wherein
the integrated document data is set such that display and non-display of the added image on the second layer is selectable.

19. A non-transitory computer readable medium comprising a program that is executable in a computing device to cause the computing device to perform a method for distributing document data, the method comprising:
receiving document data of a document;
compressing the received document data;
storing the compressed document data;
receiving image data of an image added to the document;
storing the received image data;
receiving a request for integrated document data including the document data and the image data;
generating, as integrated document data, data of a first layer that includes the document of the compressed document data and data of a second layer that is to be superimposed on the first layer, that includes the image data of the added image; and
outputting the generated integrated document data when the request is received.
